(19) United States
(12) Patent Application Publication
(10) Pub. No.: US 2014/0196430 A1
(43) Pub. Date: Jul. 17, 2014

(54) IMPLEMENT FOR EXTRACTION AND DECIMATION OF PLANT STALKS

(71) Applicant: Thomas Charles Windhausen, Meigs, GA (US)

(72) Inventor: Thomas Charles Windhausen, Meigs, GA (US)

(21) Appl. No.: 14/085,673

(22) Filed: Nov. 20, 2013

Related U.S. Application Data
(60) Provisional application No. 61/728,287, filed on Nov. 20, 2012.

(51) Int. Cl. A01D 34/835

(52) U.S. Cl. CPC A01D 34/8355
USPC 56/502

(57) ABSTRACT

An implement for extraction and decimation of plant stalks with a puller section and flail section. The puller section is driven by a motor and uses a pair of track belts with interlocking protrusions to grab plant stalks and pull them up by the root. The puller section discharges the plant stalks into a hooded flail section with flail rotor and flail knives that decimate the plant stalk into small pieces.

### PRIORITY CLAIM

The present application claims benefit of U.S. Provisional Patent Application No. 61/728,287 filed on Nov. 20, 2012.

### BACKGROUND OF THE INVENTION

1. Field of the Invention

The present invention relates to agricultural implements for attachment to the power take-off of a tractor and, particularly, to an implement for the extraction and decimation of plant stalks including cotton.

2. Discussion of the Prior Art

Cotton is picked using a harvester having heads for picking several rows at once, usually four to six rows. After cotton is picked, the stalks are left in the field and require additional processing for removal so that a subsequent crop can be planted. Further, cotton is a perennial plant and can re-grow following harvest, providing the potential for development of hostable fruit (squares and bolls) for boll weevil feeding and reproduction. Under good environmental conditions, cotton plants can generate hostable fruit in three to four weeks. Thus, it is considered important to destroy cotton stalks as soon as the crop has been harvested to aid in reducing costs for the boll weevil eradication. Present practices require several passes by mowers and disc harrows to effectively process these stalks. These several passes cause wear and tear on expensive cotton harvesting machines and require the use of fuel that is costly and harmful to the environment. Thus, what is needed is a method for removal of cotton stalks or similar plant crop stalks more efficiently.

Conventional rotary mowing can leave long pieces of crop stalks that will interfere with future field operations and hinder decomposition of plant matter. It would be more desirable to process plant stalks and leave only small debris or chips of plant material that will readily rot and become organic soil matter. Despite this long-felt need, nothing on the market today effectively pulls and shreds the stalk of a cotton plant to the root, especially with only one trip through a post-harvest crop field. Previous attempts to solve for this need have failed at least in part. For example, the Amadas puller/chopper (U.S. Pat. No. 5,953,895), pulls and chops crop matter in 12″-18″ long sections using pneumatic tires. The Amadas puller only pulls and holds a stalk momentarily and does not promote further processing of the stalk. Thus, the Amadas puller deposits the crop litter in a concentrated band, unfortunately leaving long stalks on the ground. The concentration of the band of stalks left on the ground causes future difficulty in tillage for planting new crops. The remaining root pullers available in the art, such as shown in U.S. Pat. No. 4,779,684, require the crop to be mowed before the root can be pulled, and then when the root is pulled a 12″-20″ length of usually very thick root end of stalk remains on the ground. No implement currently performs the desirable functions of removing plant stalks and then decimating those stalks into small bits for conversion to mulch.

In addition to the above deficiencies, both the Amadas chopper and the disc puller (U.S. Pat. No. 4,779,684) cause an undesirable amount of soil disturbance, which especially in a conservation tillage system does not contribute to an acceptable seed bed preparation for following crops. Stalks are often partially buried creating problems with further field work.

Thus, what is needed is an improved implement for the extraction and decimation of plant stalks such as cotton stalks that overcomes the limitations of the prior art. In particular, a need exists to pull cotton stalks from the root and then decimate these cotton stalks so that future field work can be completed without the obstacle of long and thick cotton stalks damaging equipment or inhibiting proper tillage and field preparation.

### SUMMARY OF THE INVENTION

The present implement for extraction and decimation of plant stalks operates to both extract plant stalks such as cotton stalks from the ground and shred these stalks into small pieces. Both above ground growth and below ground stem and root are pulled by two rubber track belts with interlocking protrusions that are powered by a hydraulic motor. The pair of track belts provides a puller unit that grasps the plant stalk, typically at the base of the plant, and holds the stalk as the machine moves forward. Multiple puller units are provided on the implement in accordance with the number of rows desired, usually between 4-8 rows.

The implement operates in a combination of forward ripping of plant roots and lifting the plant stalks as the plant is conveyed rearward and elevated by the angle of the puller unit. The puller unit is angled higher to the rear of the implement to fully separate the plant from the ground. The track belts evenly convey the crop stalk mass to a flail shredding unit to reduce the plant stalk and root to small mulch type chips that are then distributed evenly across the working width of the machine to the soil surface. In doing away with the normal stalk and root stubble this greatly eliminates future problems associated with a line of sharp sticks that cause plugging of tillage equipment and damage such as premature wear of tires be it on tractors or transport wheels on implements. Also, when root matter is removed from the ground the problem with the plants re-growing is eliminated, which eliminates wintering habitat for soil pest; be it disease, insects or nematodes.

The current implement improves removal of plant stalks by both removing and shredding the stalks from its root up, all in one pass. This size reduction of plant stalk material is greatly superior to the standard practice of rotary mowing, because it cuts all of the plant including the root into to small mulch like pieces. This process provides surface mulch that greatly reduces wind and water caused erosion and ultimately improves soil tilth and biology by providing a slow decaying surface covering of organic matter. Meanwhile, the present implement operates above the soil surface and does not disturb or molest the soil profile. The only soil movement is the narrow band where the root pulls up a minor amount of soil, unless the hardness or type of soil requires conditioning. Where desirable, such as heavier clay based soils, an optional plow may be used to loosen soil around the root of the plant prior to pulling.

### BRIEF DESCRIPTION OF THE DRAWINGS

FIG. 1 is a perspective view of an implement for extraction and decimation of plant stalks constructed in accordance with a embodiment of the invention having a puller section and a flail section.

FIG. 2 is a top plan view of a puller section of the implement of FIG. 1 including an embodiment of the puller units and puller drive assembly.

FIG. 3 is a top plan view of a puller unit in accordance with the invention.

FIG. 4 is a front plan view of a puller unit supported on the implement in accordance with an embodiment of the invention.

FIG. 5 is a side plan view of a puller unit and puller drive assembly in accordance with the invention.

FIG. 6 is a perspective view of a flail unit of the implement in accordance with an embodiment thereof.

FIG. 7 is a perspective view of a flail used in the flail unit of FIG. 6.

FIG. 8 is a perspective view of a flail rotor with flails attached in accordance with an embodiment thereof.

FIG. 9 is a side plan cut-away view of the implement for extraction and decimation of plant stalks illustrating the method of operation in an embodiment thereof.

FIG. 10 is a perspective view of a flail unit in an alternative embodiment having a curved hood.

### DETAILED DESCRIPTION

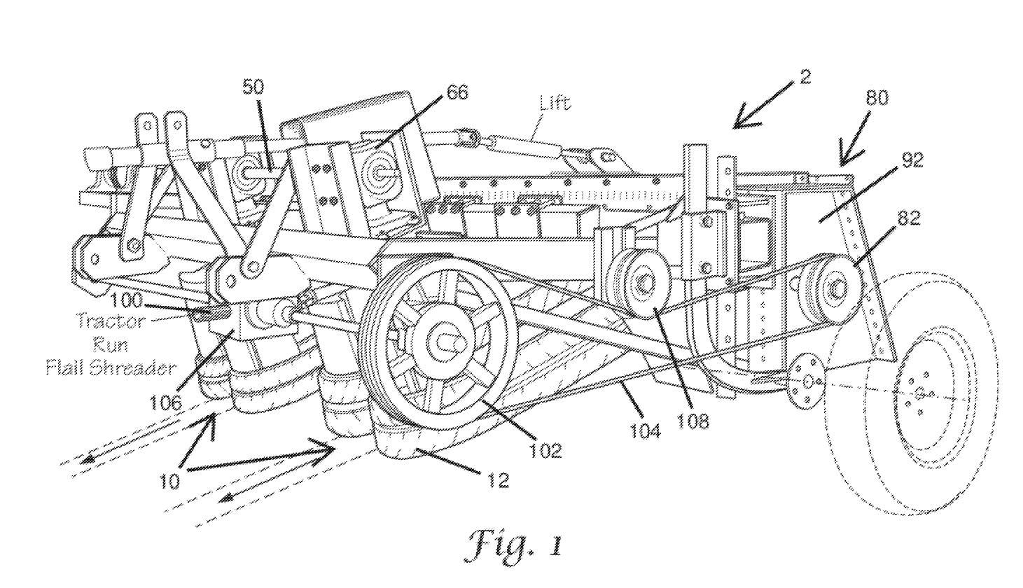

Referring now to the drawings, an implement 2 for the extraction and decimation of plant stalks is shown in FIG. 1. This agricultural implement 2 includes a PTO (power take-off) connecting shaft 100 and connects to a typical farm tractor. The implement has a puller section that extracts plant stalks such as cotton from the ground and has a flail section that decimates the stalks. The implement operates to clear a field of stalks after harvest, leaving only a decimated mulch of debris on the ground.

The puller section of the implement includes a puller unit 10 for each row having a pair of track belts 12 to extract plant stalks from the ground. As a tractor pulls the implement, plant stalks enter the front of the downward sloping puller units 10. The puller section includes a puller drive assembly 40 for driving the puller units 10. After the stalks are extracted by the puller units 10, the stalks exit the puller section into the flail section for decimation.

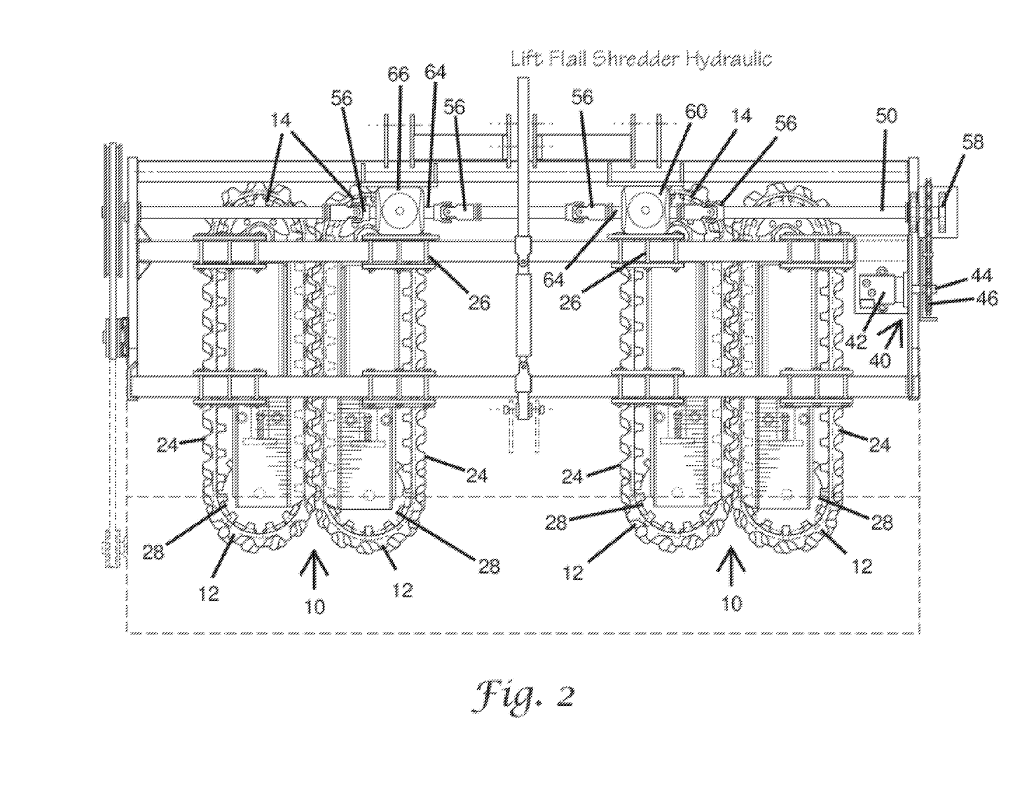

The puller section, having a combination of a puller drive assembly 40 and puller units 10, is shown in FIG. 2. The preferred implement will include multi-row puller units 10 according to the size of the implement desired. Four and six row implements are very popular, and the size of the implement may be expanded from two to four or more rows by adding additional puller units 10 and the necessary puller drive mechanics. In the exemplary embodiment of FIG. 2, the implement includes two puller units 10 for descriptive purposes. The puller units 10 connect to a hydraulic drive through the shafts shown, whereby each puller unit 10 includes a gearbox 60, 66 and shaft 64 for turning the track belts 12 on the puller units.

The puller units 10 each include a pair of track belts 12 connected within the pulling unit in parallel interlocking relationship. The track belts 12 are supported on a support structure 26 including a belt drive sprocket 14 on one end and an idler wheel 28 on the opposing end of the support structure. Each belt drive sprocket 14 includes teeth. These teeth engage holes 16 in the respective track belt 12 to drive the track belt in a loop around the belt drive sprocket 14 and the idler wheel 28. The combination of the teeth on the belt drive sprocket 14 and the holes 16 in the respective track belt 12 forms an operating roller track.

Each of the track belts 12 includes a plurality of spaced track protrusions 24 along the outer surface of the track. These track protrusions 24 on each track belt 12 are arranged in opposing relationship for the parallel track belts 12 such that the track protrusions overlap each other by resting within the gaps between the opposing tracks protrusions to form the interlocking relationship of the pair track belts 12 in a puller unit 10. The interlocking track protrusions 24 improve the grip of puller unit 10 on the crop material and convey the crop material along the track by gripping and moving the crop mass rearward and upward toward the flail unit in accordance with the mechanical angle and arrangement of the track belts 12. The typical rubber track belt 12 that is provided in the invention will be about 7 inches in width and provide for gripping a substantial portion of the plant stalk for extraction thereof.

In addition to the gripping proficiency of the track belts 12, the upward elevation angle of the puller unit 10 as shown in FIG. 1 and FIG. 5 improves separation of the roots of crop mass or plant stalks from the ground. The angle may be fixed according to a preferred mode or may be adjustable. If adjustable, the angle of attack on the tracks will vary depending on the crop from 10 to 45 degree upward from entry to exit. The implement could be used in different ways for different crops. For instance, with the puller units 10 arranged at a lower and less steep angle of attack, the implement would be able to pull more deeply rooted crops such as cotton with a more gradual pulling action, providing more dragging than lifting. Whereas on a less deeply rooted crop such as vegetables planted on plastic mulch, a very steep angle in the puller unit 10 would promote pulling the plant more vertically and reduce the tearing of the plastic.

In an alternative embodiment with adjustable puller units 10, the angle of the puller units may be adjusted through hydraulic pumps connected to the support structure 26 to pivot and raise or lower the puller units. Thereby, the optimum height and angle of the puller unit 10 can be determined for a particular crop of plant stalks for optimum decimation. Of course, a fix angle may be provided that is optimized for most crop scenarios to reduce the complexity and cost of the implement. In addition, the length of the puller unit 10 may vary. The typical length of a desirable puller unit 10 will be approximately 36 inches from the entry end of the track belts 12 to the exit end where the crop mass is engaged by the flail unit, providing a 3 foot grip length for extraction and removal of plant stalks.

The combination of the belt drive sprocket 14 and idler wheel 28 maintains each track belt 12 in sufficient tension for rotation of the track belt around the support structure 26. The idler wheel 28 moves rearward on a slide track 30 to remove any excess slack between the idler wheel and the track belt 12. A tension adjustment bolt 32 moves the idler wheel 28 to tighten and adjust the tension. Once the proper desired tension is achieved, then retention bolts 36 are tightened to retain the position of the idler wheel 28 within the plates 34 forming the portion of the support structure 26 that supports the idler wheel. In a preferred embodiment, the idler wheel 28 provides a smooth rolling surface on the back of the support structure for the track belt 12, as opposed to the toothed belt drive sprocket 14 that operates to engage the track belt with force.

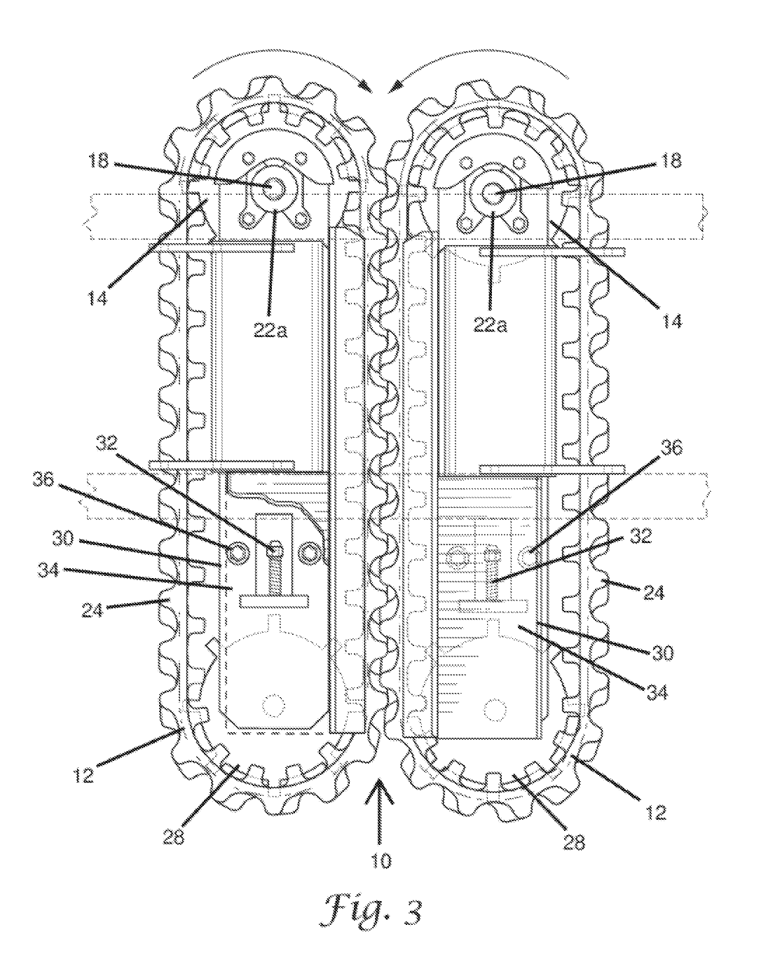

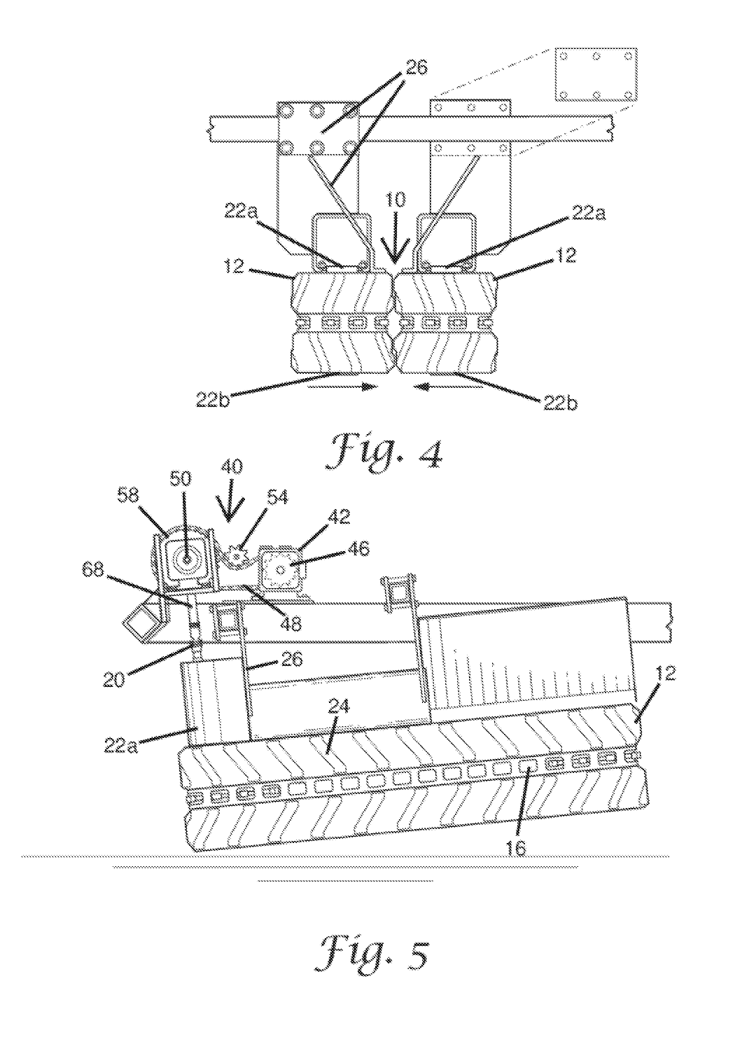

The belt drive sprocket 14 for each track belt 12 is supported on the support structure 26 by a pair of support bearings 22a, 22b providing top support bearing 22a and bottom support bearing 22b. A belt drive sprocket 14 shaft extends from each belt drive sprocket as shown in FIG. 3, and a pulling force is applied to the belt drive sprocket via a universal joint 20 connected to one of the belt drive sprockets on each puller unit 10 as shown in FIG. 5. Each respective puller unit 10 has a drive side of the unit in which the track belt's belt drive sprocket 14 is connected to a universal joint 20 connecting the belt drive sprocket's shaft to the puller drive assembly 40. This side of the puller unit 10 connected to the drive assembly performs the mechanical operation of engaging the track belt 12 and driving the puller unit 10. The remaining track belt 12 on the passive side will move with engagement by the interlocking track protrusions 24.

The universal joint 20 connects the belt drive sprocket shaft 18 to the puller drive assembly 40 via a bottom output shaft on a respective gearbox 60, 66. Each puller unit 10 may have a separate gearbox output as shown in the exemplary embodiment of FIG. 2. The puller drive assembly 40 includes a hydraulic motor 42 for driving the puller units 10. As shown in FIG. 5, the hydraulic motor 42 includes a motor shaft 44 with a motor sprocket 46 and connects to a front counter shaft 50 through a drive chain 48 and a front counter shaft sprocket 52. A drive chain tensioner 54 is shown for governing the tension in the drive chain.

A typical arrangement as shown includes a slip clutch 58 attached to the front counter shaft 50 that will momentarily disconnect power transmission to the front counter shaft 50 in the event the implement encounters an obstruction such as a root or rock that is pulled into a puller unit 10. The slip clutch 58 helps to avoid damage to the track belts 12 or gearboxes in the case of an impassable object. Universal joints 56 connect the front counter shaft 50 to each three shaft gearbox 60, 66 to transfer power from the slip clutch 58 to each gearbox and respective puller unit 10. As shown in the embodiment of FIG. 2, the front counter shaft 50 connects to the first row puller unit gearbox 60 by a universal joint 56 that is connected to a gearbox connecting shaft 64 extending from the side of the gearbox. The bottom output shaft 68 on the gearbox extends from the bottom of the gearbox and connects to the belt drive sprocket shaft 18 as discussed above. An additional gearbox connecting shaft may extend from the other side of the gearbox and connect to an additional length of the front counter shaft 50 by a universal joint 56, and then the next second row puller unit gearbox 66 connected to the front counter shaft 50 in similar fashion using another universal joint 56. This puller unit drive system is repeated with consecutive gearboxes connected along the length of the front counter shaft 50 in accordance with the number of rows and puller units 10.

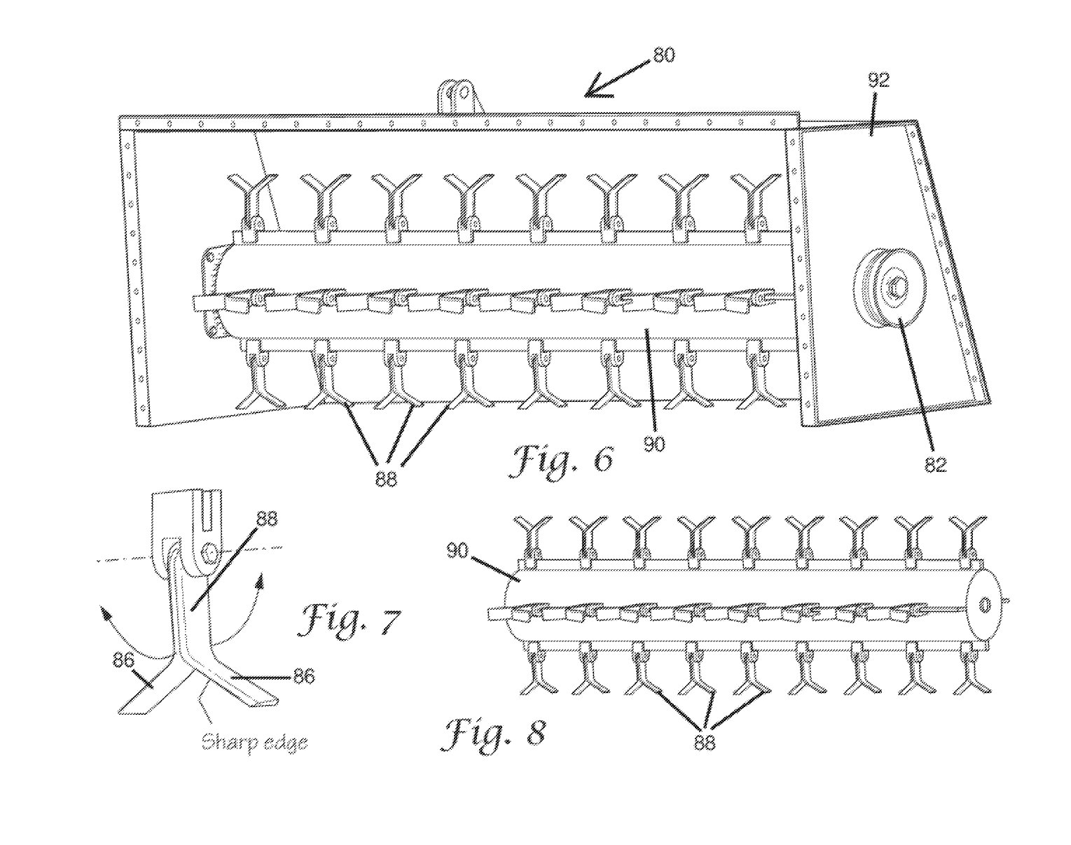

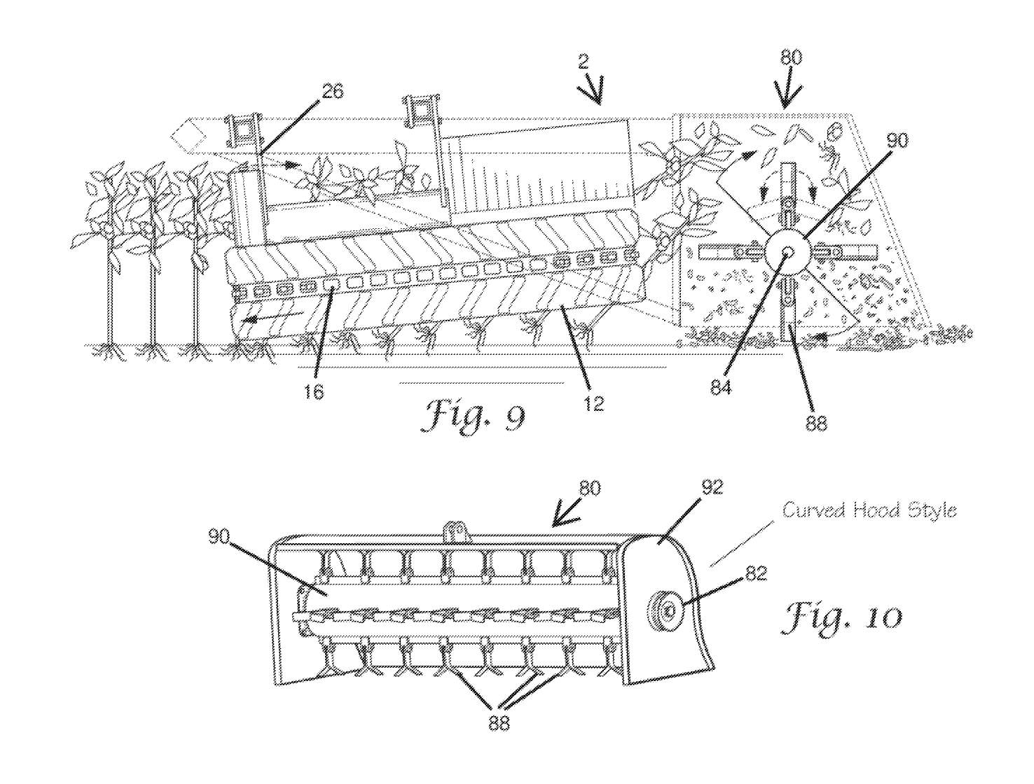

Referring now to FIGS. 6-10, the flail shredder assembly includes a flail unit and drive system for flail unit. The flail unit 80 of the implement operates to receive the pulled plant stalks as discussed and shred them as shown in FIG. 9. The flail unit 80 may be operated by connection to a tractor's PTO. The connection of the implement to the tractor PTO includes a drive shaft 100 for driving a flail unit 80 situated behind the puller section of the implement. The drive shaft is connected through a center mounted drive gearbox 106 to a pulley system that includes a drive pulley 102 that pulls a multiple groove drive belt 104 connected to a flail shredder assembly of the flail unit 80. The drive belt 104 connects via a flail rotor pulley 82 on a flail rotor shaft 84 in the flail unit 80. A tensioner 108 operates to control tension in the drive belt 104 and ensure proper operation. The flail rotor shaft 84 operates at high speed causing flail knives 86 to cut sections of plant stalk entering the flail unit 80. Said shaft may rotate at speeds of 2000 rpm or more causing the tips of the flail blades to move at a speed of 160 mph or more. The cutting of stalks at such high speed decimates the stalks into very small pieces.

The flail knives 86 are “L” shaped and combined in pairs for connection to the flail rotor 90 as shown in FIG. 8. The pair of flail knives 86 forms a “Y” shaped flail 88 or an inverted “Y” when hanging downward from a bracket. Each flail 88 is pivotally connected to flail rotor 90 by a bracket extending from the flail rotor as shown in FIG. 7. The flail rotor 90 is rotated by the flail rotor shaft 84 to spin at high speed, which causes the pivotally connected flails 88 to whip outward from centrifugal force as the rotor turns. The blades of the flails 88 are extended but pivotally mobile and provide a resilient cutting edge. The flail rotor 90 rotates clockwise such that the flails 88 move from the bottom forward to churn plant stalk further into flail unit 80.

A flail hood 92 of the flail shredder assembly covers the flail unit 80 as shown in FIG. 6 and keeps stalks in the flail unit during the cutting phase from decimation and also protects the flails 88. The flail hood 92 may be arranged to maximize shredding by adjusting the tolerance between the hood and the flails and also by adjusting or changing the shape and structure of the hood. For example, a flat flail hood 92 may be provided as shown in FIG. 6 for a simple and economical hood. Alternatively, a curved flail hood 92 as shown in FIG. 10 with less distance between the flails 88 and bottom surface of the hood may be provided for improved operation or aesthetic appearance. In one particular embodiment the entrance clearance between the flails 88 and the flail hood 92 may be reduced to 1.9 inches and the exit clearance between the flails and the hood may be reduced to 1.1 inches. These tolerances may maximize the effectiveness of the flails 88 within a curved flail hood 92. The actual tolerances and hood structure may be adjusted further through experimentation and according to the type of plant stalk being decimated.

1. An implement for extraction and decimation of plant stalks comprising:
a puller section having a puller unit and a puller drive assembly, said puller unit having a pair of track belts with interlocking track protrusions and said puller unit connected to the puller drive assembly; and
a flail shredder assembly having a flail drive assembly and a flail unit arranged for receiving plant stalk matter from the puller unit and said flail unit including flails on a flail rotor, said flail drive assembly having a powered drive shaft connected to said flail rotor.

2. An implement for extraction and decimation of plant stalks as in claim 1 in which said track belts are arranged at an upward angle from an entry end for receiving plant stalks to an exit end for discharge of plant stalks into the flail unit.
